(19) United States
(12) Patent Application Publication
(10) Pub. No.: US 2018/0041338 A1
(43) Pub. Date: Feb. 8, 2018

(54) Methods and Apparatuses to Facilitate Protection of Sensitive Data Online and Reduce Exposure in the Event of a Data Breach

(71) Applicant: Oxford-Downing, LLC, Albany, NY (US)

(72) Inventors: Tyler Nighswander, Milpitas, CA (US); Craig Simon Pickard, NY, NY (US); Stefani Bardin, Brooklyn, NY (US); Sue Lynn Thomas, Berkeley, CA (US)

(21) Appl. No.: 15/665,357

(22) Filed: Jul. 31, 2017

Related U.S. Application Data
(60) Provisional application No. 62/370,635, filed on Aug. 3, 2016.

(51) Int. Cl. H04L 9/32; H04L 9/30; H04L 29/06; H04L 9/14

(52) U.S. Cl. CPC H04L 9/3226; H04L 9/14; H04L 9/30; H04L 9/3236; H04L 63/0428

(57) ABSTRACT

The present invention can provide a system to facilitate encryption/decryption of sensitive data/information online. It will revolutionize the way data is encrypted because it provides a way for individuals to discretely protect their data both at rest and in motion, and it allows users the ability to decide whom the data are shared with. The present invention can become valuable to businesses and companies by reducing the exposure of sensitive information in the event of a data breach, and by extension it reduces costs related to recovering from a data breach.

### CROSS REFERENCE TO RELATED APPLICATIONS

This application claims priority to U.S. provisional application 62/370,635 filed Aug. 3, 2016, which is incorporated herein by reference.

### TECHNICAL FIELD

The present invention relates to cryptography, encryption/decryption, steganography and the protection of online data in documents and images, both in motion and at rest.

### SUMMARY OF INVENTION

Embodiments of the present invention provide Client-Side Encryption, Form Field Encryption, Steganography using Fortezza for Randomizing Data and DNA as Decryption Key with Blockchain as a granular time stamp.

Systems currently in place to handle the safekeeping of sensitive, personal data online have not evolved to keep pace with the number of data breaches happening on a regular basis. Whether breaches are perpetrated by hackers, or as the result of poor business practices, many companies responsible for protecting our personal information do not provide adequate security.

The present invention can provide a system to facilitate encryption/decryption of sensitive data/information online. It will revolutionize the way data is encrypted because it provides a way for individuals to discretely protect their data both at rest and in motion, and it allows users the ability to decide whom the data are shared with. The present invention can become valuable to businesses and companies by reducing the exposure of sensitive information in the event of a data breach, and by extension it reduces costs related to recovering from a data breach.

Through the use of unique encryption and steganography systems carried out through a secure protocol, the present invention:

uses client-side encryption and decryption of documents/forms/images

allows for decryption of select form fields while keeping the remaining part of the encrypted data in its encrypted format

can be used for the storage, retrieval and sharing of forms/documents/data/images.

Creates steganographic images using Fortezza for randomizing encrypted data in a cover image

Can utilize DNA as the key to decrypt messages/data in steganographic images

### BRIEF DESCRIPTION OF THE DRAWINGS

FIG. 1 is an illustration of topics that can be helpful in understanding the present invention.

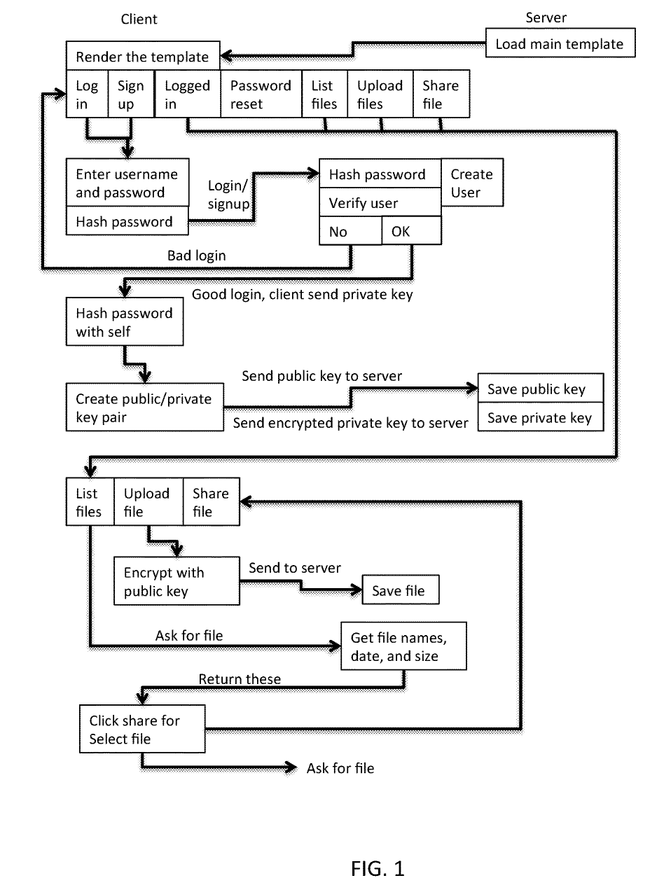

FIG. 2 is a flow chart for an example online platform to show what happens on the front end and back end of the encryption process for a typical document and image.

FIG. 3 is a flow chart for an example online platform to show what happens on the front end and back end of the encryption process for a typical document and image.

### DETAILED DESCRIPTION OF THE INVENTION

Embodiments of the present invention provide a way for users to more fully protect personal information and limits the exposure of sensitive data in the event of a data breach. With the use of client-side encryption, password hashing and a unique user-generated lock and key configuration, every time an authenticated user shares or transmits data and messages a new key is generated and re-encryption of said data and message occurs. Using known Python and JavaScript Libraries configured with AES 256 bit keys and a RSA 2048 asymmetric cryptographic algorithm the system can convert plaintext to ciphertext. Form field encryption and layers of access to data provide extra security against the entire content of files and documents from being compromised during potential data breaches. The system can also include state of the art steganography in the form of current modalities of RGBA value encryption with an added layer of Fortezza keys which constantly randomize the value/character allocation making a breach significantly more difficult. The system's steganography platform also allows for the use of DNA to function as the most unique and individualized form of a key to unlock the data from the image. The encryption of data in secure communications can be used in conjunction with the storage, processing and retrieval of data/documents/images for several industries, including but not limited to Health Care, Lending, Financial Services, the Arts, Education, Music Industry, Retail, Real Estate and the Individual Consumer Market.

Standard SSL/TLS encryption technology is currently used to protect data in transit to and from servers. There is also the NIST sanctioned AES 128/192/256 key lengths and RSA Algorithm 1024/2048 bit long chain as industry standard guidelines. However, this will not fully protect against possible compromises of the server itself. Other encryption technologies, such as PGP, can protect data at rest, but are difficult to manage; they require technological expertise and careful management of key materials, the complexity of which requires a very explicit and rarefied skill set. Embodiments of the present invention can uniquely handle authentication and identity management, two large problems in asymmetric cryptography. This means documents sent between parties are encrypted by the system, since the system knows which public and private keys belong to which users and recipients; the private key is stored on the user/client side using URL fragments and the public key is stored on the system server using client side Java Script as a means of authentication.

Embodiments of the present invention provide a platform that uses a website, servers and centralized database to handle identity management, authentication, and key rotation, keeping the intricacies of performing asymmetric cryptography invisible to the user. By handling encryption in the user's browser on the client side, data can be encrypted before being transmitted over the internet to our servers. SSL/TSL protect transmitted information being sent over the internet and the encryption ensures that our servers will not receive decrypted data.

Standard encryption now allows for encryption/decryption of entire documents. Embodiments of the present invention support full or partial decryption. Users can select individual form fields within an entire document that can be decrypted while the remainder of the document stays encrypted, this means that if a data breach occurs only designated form fields could potentially be compromised while the rest of the document remains encrypted.

Standard steganography currently allows for encrypted data to be embedded in images but the recovery of that data is accessible with known algorithms if an outside individual knows what to look for because the encryption remains fixed. The steganography tools used in the present invention can randomize the encrypted data in the image by employing the Fortezza algorithm as a key in conjunction with Blockchain, which functions as a granular time stamp for the platform ledger. This creates extra layers of security against breaches. Embodiments of the present invention can also support the use of DNA as the key for decoding steganographic images.

A software embodiment of the present invention can comprise instructions stored in memory that, when accessed by a general purpose computer, impart functionality to the computer to implement the operations described herein and provide the benefits of the present invention. As an example, a software embodiment can comprise the following components:

### Backend:

### Django 1.9

Django REST framework 3.4.1
Scrypt algorithm for password hashing+storage on the server side.

### Frontend:

AngularJS for client side operations
Cryptico javascript library for RSA decryption, encryption, and generation
Crypto javascript library for AES encryption
PDFjs for PDF reading and field selection
Current endpoints for API
Storing privately:
Endpoint for uploading files
Endpoint for downloading uploaded files

### Sharing:

Endpoint for sent files.
Endpoint for sending files.
Endpoint for received files.
View for sent files also loads permission map.
Only able to share files the user owns.

In an example embodiment, a User creates a Profile. The user uploads documents/images, encrypts data, and selects data fields that will be allowed to be decrypted by the Recipient. The platform encrypts all data and generates a key. The key for the user is derived from the user's password plus entropy from the server. The key can be encrypted with a publically available key using client side Java Script and is sent to the server. The public key can be stored on the server associated with the user's account. The private key is for the User. The public key is given to the Recipient by the User in order to access information that can be decrypted. Recipient uses public key to retrieve and decrypt all or selected parts of document/forms/images. The user's symmetric public key will expire after 1 hour after which a new one can be generated for the same data. Encrypted data can be stored for up to 1 year, with the option to renew.

Users can choose to download standard documents from the servers, as well as uploading the User's own documents/images.

Embodiments of the present invention can encrypt data and information on forms, documents and in images. The embodiment can comprise a client-side encryption tool with above industry standard level security and with the capability to allow a user to indicate individual form fields within an entire document that may be decrypted by someone they wish to share the document with. All encryption holds while in transit or at rest. Embodiments can be utilized independently or as an add-on product/tool for many industries and businesses Health Care, Financial Services, Lending, the Arts, Real Estate, Education, Music Industry, Retail and the Individual Consumer Market.

An example application of the present invention is in the Healthcare industry to reduce the risk of potential loss/exposure of sensitive patient information. The invention's unique steganography tool can be used in conjunction with medical images to embed patient information within an x-ray or MRI image, for instance. Since the encrypted data is randomized within the image, the possibility of the data being decrypted by someone other than the intended recipient is far more difficult than the current methodology used in standard steganography wherein if an individual knows what to look for the data is easily decrypted. The steganography tool can use patient DNA as a unique and wholly individual key for decryption.

In the HealthCare industry, the present invention can be used by patients, providers, care coordinators, insurers, hospitals, and clinics.

In the Financial Services/Lending industry, the present invention can be used by lending institutions, banks, credit unions, underwriters, loan applicants, escrow companies, title companies, investment bankers, investors.

In the Arts, the present invention can be used by museums, galleries, auction houses to protect data related to buyer information, donor information, provenance, conservation information and sales records.

In the Real Estate industry, the present invention can be used by applicants, agents, brokers, landlords, brokerage firms, property management firms, and real estate listing aggregator sites.

In the Education industry, the present invention can be used by schools to store student, employee and faculty data, and by students submitting applications to schools, colleges and universities.

In the Music Industry, the present invention can be used by artists to embed lyrics, rights, contracts, royalties within an image (album cover) using data randomizing steganography along with a blockchain ledger system. This can be used by musicians, records labels, academic institutions, music schools, and technologists.

In the Retail industry, the present invention can be used by retailers who harvest and store client information related to tracking purchasing habits and for applications for employment.

For the Individual Consumer Market, the present invention can be used by individuals to store and share sensitive personal information, documents and images with multiply layers of security and encryption.

After adoption in early target markets, the present invention will be expanded for use in other markets where secure storage of documents and data security is required for ease of access, application, evaluation, sharing and safe storage.

The present invention can provide useful features, including those described below.

Encryption Security

The system provides a platform that is safe for sharing and storing information. All data, forms, documents and images are encrypted during transfer and at rest.

The system provides a platform that can be used to store document and image data long-term. Users may choose an end-date for storage of data and the system will enforce the user's preferred settings (for instance, delete application file after 60 days).

The system provides a platform that uses client-side encryption, state-of-the-art encryption and steganography technology and best practices to keep sensitive data secure in transit and at rest. Encrypted data can be decrypted by a recipient who has received both the document and decryption key from the document owner. The document owner defines which individual form fields will be made visible to a recipient upon decryption; this prevents comprehensive access to data stored and sent using the platform.

Comprehensive Network Security

General network security is key to data protection. The system provides a platform that can protect against internet-based threats with constant monitoring and frequent security audits.

Steganography

The system provides a platform that uses steganography tools surpass the current standard for encrypting data within an image, making it far more difficult for information to be decrypted by anyone other than the intended recipient. The system provides a platform that can randomize data within the image using Fortezza as a key and Blockchain as a ledger and a time stamp for decoding encrypted data. The system provides a platform that also offers the ability to utilize a user's DNA as a key for decrypting information in steganographic images.

Data Center

The system provides a platform that can be partnered with secure cloud hosting providers to provide a highly secure and scalable environment.

Account Settings and Permission Levels

The system provides a platform that provides each user with a unique username and password that must be entered each time a user logs in. The password is hashed Usernames and passwords are not stored by the platform.

The system provides a platform that offers various Permission Levels for people being authorized to decrypt forms/documents/images, so individuals see only that information which is pertinent to them. For instance, a hospital setting may have administrative, primary physician, consulting physician, lab/testing, nutritionist, and therapist settings.

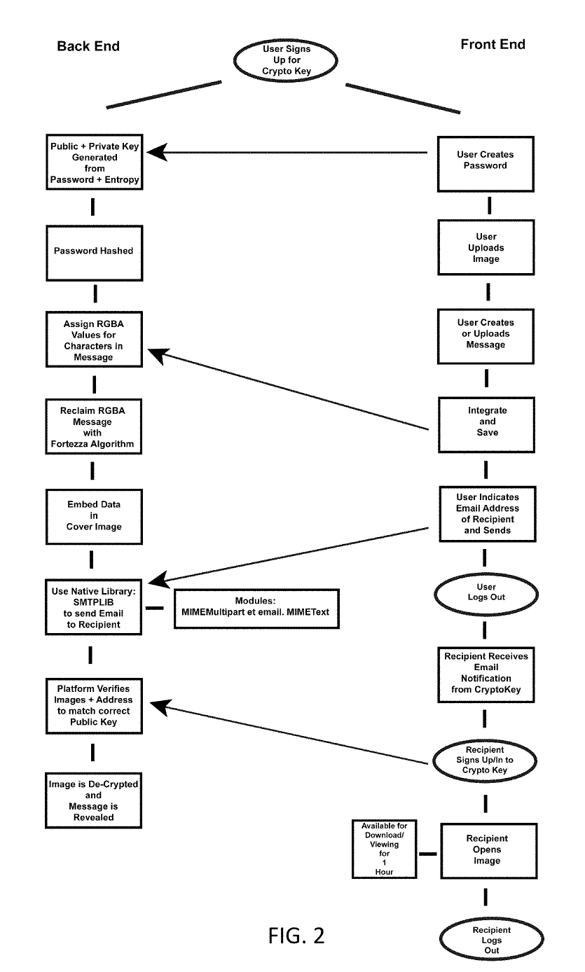

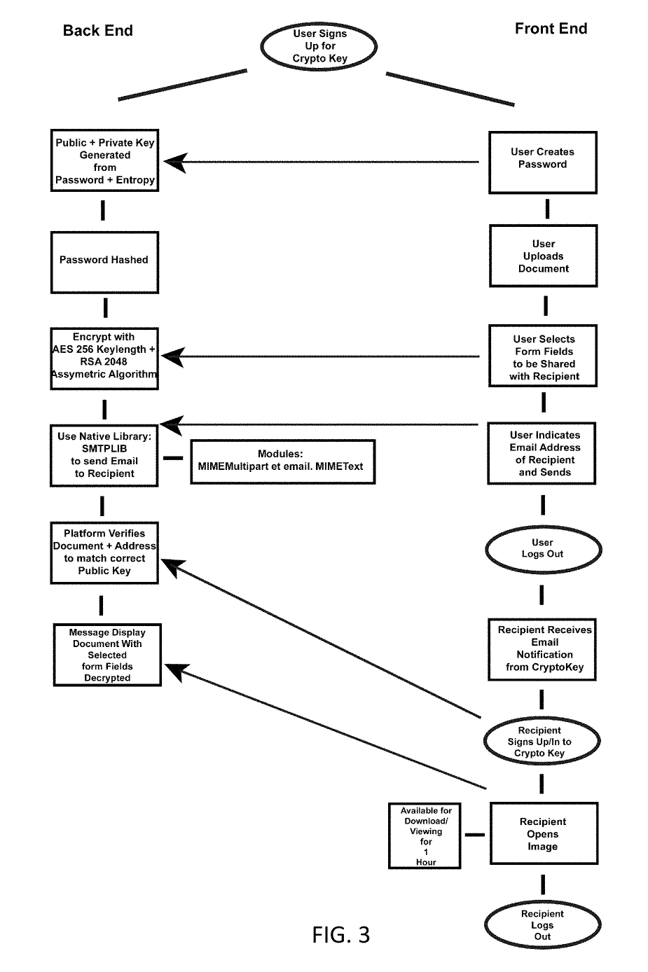

FIG. 2 and FIG. 3 provide flow charts for an example online platform to show what happens on the front end and back end of the encryption process for a typical document and image. They illustrate what happens when a user signs up, signs in, encrypts a document or image and then shares it with a recipient.

Embodiments of the present invention can be considered as comprising two components: the platform's servers and the user's browser. The user's browser is responsible for handling encryption. This keeps sensitive data away from the platform's servers. The platform's servers store data such as hashes of user passwords, public keys, and encrypted data sent by users. When users authenticate to the platform, their browser will derive an encryption key from their password. This allows the user to decrypt the data stored on the server, modify it, and re-encrypt it before sending it back. If a user (Alice) wishes to send sensitive data to another user (Bob) of the website, the platform will automatically find the public key information for Bob and send it to Alice's browser. Alice will generate a new encrypted key and use it to encrypt data to send to Bob through the platform servers. To end users, all aspects of this process are transparent.

The platform supports various Permission Levels for Recipients who have been authorized to decrypt documents/images. This way individuals see only that information which is pertinent to them. For instance, the platform at work in a hospital setting may have permission levels related to job functions, such as: primary physician, lab/testing, nutrition, therapy, consulting physicians, administrative, etc.

Embodiments of the invention can be used in various settings, as described below.

at use in the Health Care market:

For PATIENTS

Patient Profile/New Patient Data/History forms

Patient creates key to share data with select recipients

For PHYSICIANS

Patient care/history/treatment records

Share patient data with other physicians, health care providers

For CARE COORDINATORS

Patient care/history/treatment records

Share patient data with physicians, health care providers

For DIAGNOSTICS/TESTING

Medical images can contain embedded, encrypted data using steganography

For ADMINISTRATIVE PERSONNEL

Billing

Instant Sharing

Patients can send completed forms to a hospital/physician/provider using a smartphone, tablet or computer.

Physicians can share patient data with others involved in the patient's care plan

Forms & Documents File Cabinet

Patients can upload supporting images/documents/forms to their personal File Cabinet and access as needed. Forms/documents/data/images are encrypted and can be updated as necessary.

Access from Anywhere

The platform can work on Mac, PC, desktop, mobile devices and tablets. Users can access the web-based system from any device.

Accessibility

The platform can be web-accessible for persons who use keyboard interaction or assistive technology.

Storage

Optional long-term storage of encrypted data is available to users for a fee, with the possibility of annual renewal

in use in the Real Estate market:

For APPLICANTS (Renters)

Renter Profile and Application

Applicants provide data in order to auto-fill standardized documents/forms.

Data, documents and forms are saved for use in applying to as many listings as they like.

The Renter user creates a key to unlock and access their data.

Accessibility

The platform can be web-accessible for applicants who use keyboard interaction or assistive technology.

Storage

Optional long-term storage of encrypted data is available to users for a fee, with the possibility of annual renewal.

Through the use of unique encryption and steganography systems carried out through a secure protocol, embodiments of the present invention can provide one or more of the following:

uses client-side encryption and decryption of documents/forms/images;
allows for decryption of select form fields while keeping the remaining part of the encrypted data in its encrypted format;
can be used for the storage, retrieval and sharing of forms/documents/data/images;
Creates steganographic images using Fortezza for randomizing encrypted data in a cover image and Blockchain as the ledger of record for time stamp verification;
Can utilize DNA as the key to decrypt messages/data in steganographic images.

Those skilled in the art will recognize that the present invention can be manifested in a variety of forms other than the specific embodiments described and contemplated herein. Accordingly, departures in form and detail can be made without departing from the scope and spirit of the present invention as described in the appended claims.

What is claimed is:

1. A tool for providing client-side, granular encryption of data on forms/documents/images comprising:
(a) User determines form fields on documents/images which will be made available for decryption;
(b) Data is encrypted at rest and in transit;
(c) Encrypted version of forms/documents/images are stored on platform servers;
(d) User can share entire encrypted files or select portions thereof to be shared with others by generating an assigned public key; and
(e) User can store encrypted files on platform servers for a finite period or for an extended timeframe.
